(19) United States
(12) Patent Application Publication
(10) Pub. No.: US 2005/0183473 A1
(43) Pub. Date: Aug. 25, 2005

(54) Pelting system

(76) Inventor: Florient Jeanveau, Sudbury (CA)

Correspondence Address: MIKE M. GAUTHIER, 959 ELISABELLA STREET, UNIT C, SUDBURY, ON, P3A 5K1, CA

(21) Appl. No.: 10/784,286

(22) Filed: Feb. 24, 2004

(51) Int. Cl. C14B 1/26

(52) U.S. Cl. 69/19

(57) ABSTRACT

The present invention relates to a fur-pelt system adapted to maintain the highest in pelt quality in relation to industry standards. The pelt system comprises: a stretch board having a generally rectangular form and a planar surface through which a plurality of evenly spaced perforations are made to accept nails or the like. Several sized patterns are provided in order to best fit a pelt to the largest pelt size according to industry specifications with minimal amounts of waste fur. A user thereby estimates the end-size of a newly caught fur and proceeds to stretch said fur into the closest to perfect form desired by industry thereby increasing user's chances of a more valuable pelt.

### FIELD OF THE INVENTION

The present invention relates to a fur-pelt system adapted to maintain the highest in pelt quality in relation to industry standards. The pelt system comprises: a stretch board having a generally rectangular form and a planar surface through which a plurality of evenly spaced perforations are made to accept nails or the like. Several sized patterns are provided in order to best fit a pelt to the largest pelt size according to industry specifications with minimal amounts of waste fur. A user thereby estimates the end-size of a newly caught fur and proceeds to stretch said fur into the closest to perfect form desired by industry thereby increasing user's chances of a more valuable pelt.

### BACKGROUND OF THE INVENTION

Trapping for fur has been a long-lived trading activity, and many make a living doing so. However, as the ages advanced, fur buyers have been increasingly particular about the furs they purchase, expecting more from traders even at lower trading prices.

In the last few years, the fur industry has come to standardize pelt shapes and sizes, in that, for example a beaver's pelt is categorized in seven different sizes of a specific oval shape.

It is desirable for trappers to obtain the largest pelt possible while maintaining this desired shape at the same time, all while creating the least waste possible.

The applicant is aware of several attempts in prior art to provide means stretching pelts to a desired shape. An example may be had by referring to prior art U.S. Pat. No. 2,283,367 of Hintz, issued May 19, 1942 depicting a resilient inter-connected band forming a circle having a plurality of slidable pins adapted to attach to said band while a pointed tip protrudes upward from the upper edge of said band thereby providing pelt attaching means to said circular band. However, the natural geometric form of a looped band is in fact circular, not oval therefore failing to accurately target the oval form desired by buyers.

Another example of prior art may be had in referring to U.S. Pat. No. 2,290,457 of Taylor, issued Jul. 21, 1942, which depicts a frame work adapted with an array of return hooks attached thereto, and slidable interconnections between four hooked member. However effective this invention may be to literally stretch pelts, it does fail in providing guidance to form and size of said pelts.

Another example of prior art may be had in referring to U.S. Pat. No. 2,494,949 of Langdahl, issued Apr. 21, 1947, which describes yet another circular band on which bead chains hooked to a pelt and attached to said band. Again this invention fails to provide the desired templated size and form.

While many attempts have been made to provide trappers with means of pelting furs, none of these prior art inventions seem to provide means of accurately stretching a pelt to conform to measurable industry standards all while reducing fur waste in the process.

### SUMMARY OF THE INVENTION

It is thus the object of the present invention to provide trappers with means of pelting furs, having means of accurately stretching a pelt to conform to measurable industry standards all while reducing fur waste in the process.

In one aspect of the invention, a printed-paper template and instructions may be provided to user.

In another aspect of the invention, prefabricated pelt boards may be provided.

Accordingly, the system of the present invention provides trappers with means of pelting furs, with means of accurately stretching a pelt to conform to measurable industry standards all while reducing fur waste in the process.

The utility of this device includes but is not limited to furs.

### BRIEF DESCRIPTION OF THE DRAWINGS

These and other advantages of the invention will become apparent upon reading the following detailed description and upon referring to the drawings in which:—

FIG. 1 is a perspective view from above of an embodiment of the pelting system of the present invention.

FIG. 2 is a front elevation view of an embodiment of the pelting system of the present invention.

FIG. 3 is a cross-sectional view taken from FIG. 2 of an embodiment of the pelting system of the present invention

FIG. 4 is an alternate cross-sectional view taken from FIG. 2 of an embodiment of the pelting system of the present invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

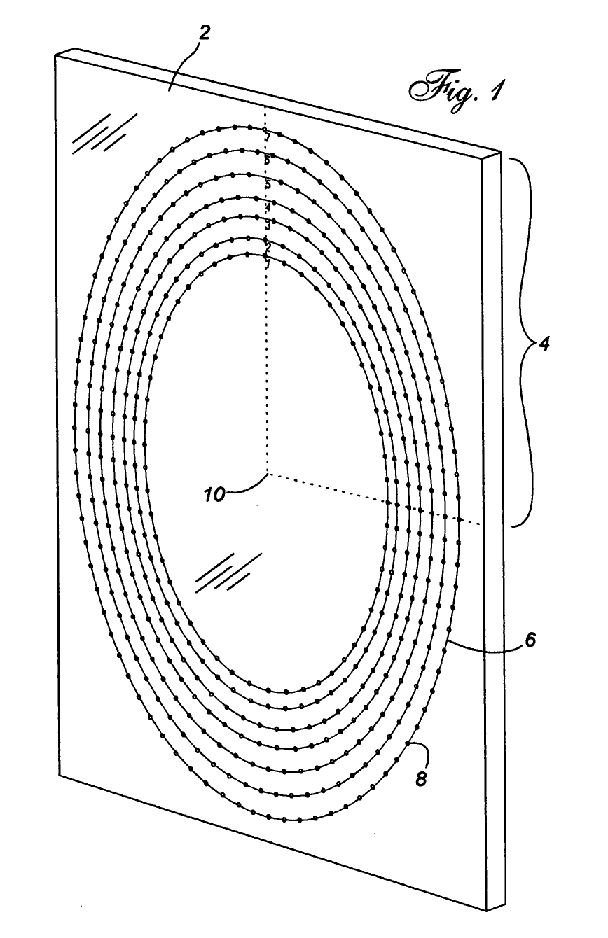

Turning to the drawings, in particular, FIG. 1 which illustrates an embodiment of the pelting system of the present invention comprising: a rigid planar sheet material 2, template guide 6, and a plurality of evenly-spaced perforations 8. The perforations 8 traversing through the rigid planar sheet material are tilted outwardly when view from the rear to the front of said sheet and each perforation 8 is beveled at entry in order to promote easy entry of nails during use. In an alternate embodiment, a thin printed paper sheet can be provided having one quarter of the template as shown in indicia 4 in reference to a central point 10 so as to enable user to perform the perforations onto a sheet material of his/her choice.

Turning now to FIG. 2, a front elevation view of an embodiment of the pelting system of the present invention depicting: a rigid planar sheet material 2, template guide 6, and a plurality of evenly-spaced perforations 8 wherein when stretching a pelt into a desired oval shape, the user can apply more force on any edge while the pelt is still flexible and adaptable so as to not waste any fur in order to end with an oval pelt. Again, a user can utilize a thin printed-paper template of one quarter the full template to mark the locations of the many perforations 8 arrayed at a common point 10 thereby enabling the user to select the rigid sheet material of his/her choice.

FIG. 3, illustrates a cross-sectional view taken from FIG. 2, wherein said illustration further depicts the tilt of said perforations 8 into the rigid sheet material 2. This provides assurance that the nails 7 will not slide out from their desire inserted position within the perforations 8 when the pelt 5 dries and attempts to shrink.

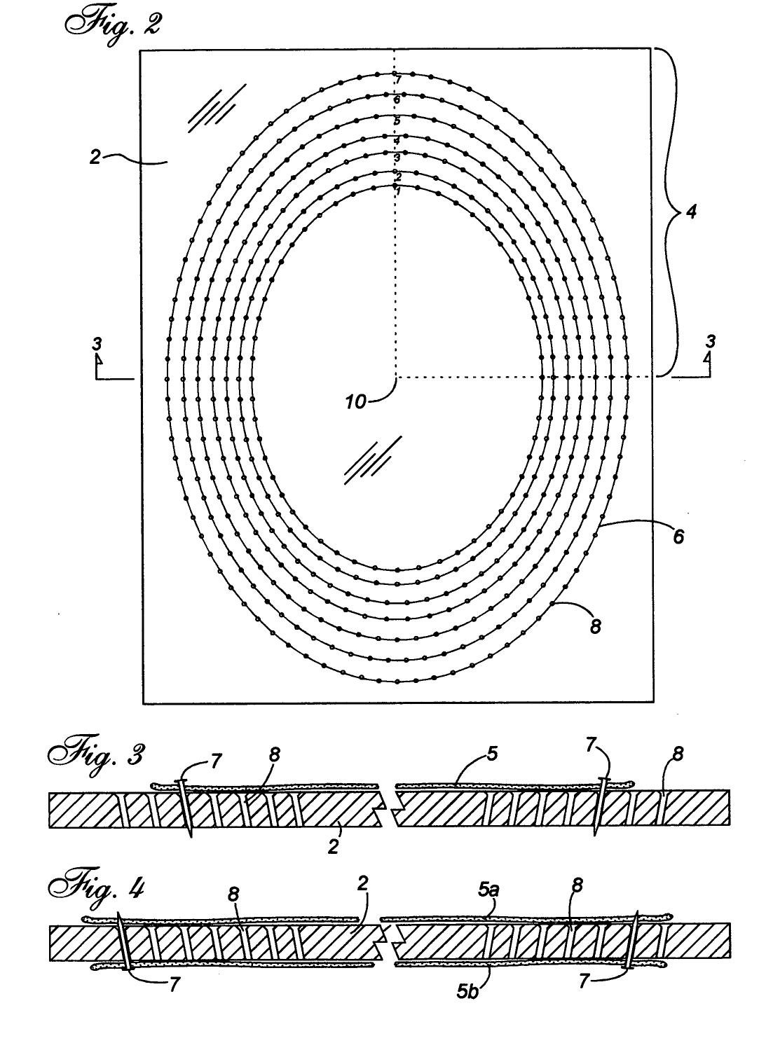

Referring now to FIG. 4, a similar depiction as FIG. 3 further illustrating an alternative method wherein two pelts 5a and 5b may be stretched at once, enabling a more cost effective use of the rigid template sheet. First, a user installs the first pelt 5b as in FIG. 3, then, before it begins to dry, the user can stretch a second pelt 5a on the reverse side of sheet 2 using the same nails 7 as used with the first pelt 5a installation. Due to the tilt of the perforations 8, the outward-pointing nails will suffice in holding the second pelt 5a in place, even when under stress when drying.

Therefore, fur trappers and traders can all benefit from evenly stretched pelts that are not only of the desired form but made to the largest size possible without the commonly know waste using conventional methods and devices. Furthermore, traders will further benefit from the pelts in that sellers can get more financial reward by producing higher quality pelts at a more efficient cost, and buyers will benefit from more usable area of said pelts.

1. A pelting system comprising:
a. a template having the standard form and size of industry standard pelts,
b. a plurality of evenly-spaced perforations along the periphery of each size template,
c. pointed nails,
d. a method in which to gain the most from a fur pelt,

2. The pelting system of claim 1 wherein said template may come from a printed sheet material to be transferred to a rigid planar sheet material of suitable thickness to provide lateral support to nail.

3. The pelting system of claim 2 wherein the rigid planar sheet material is preferably plywood.

4. The pelting system of claim 1 wherein the plurality of perforations have beveled edges so as to ease the entry of a nail.

5. The pelting system of claims 1 and 4 wherein the plurality of perforations further comprise a slight outward tilt when regarded from rear to front of sheet.

6. The pelting system of claim 1 wherein the pointed nails are further sharpened so as to prevent further damage to pelt edge.

7. The pelting system of claims 1, 4 and 5 wherein the perforations traverse the entire thickness of the rigid planar sheet material.

8. The pelting system of claims 1, 4, 5 and 7 wherein said perforations have an diameter slightly greater than the outside diameter of the pointed nails.

9. The pelting system of claims 1 through 8 wherein use thereof is to increase the accuracy of pelt output in industry so as to make the most of each fur.
